(19) United States
(12) Patent Application Publication
(10) Pub. No.: US 2006/0097845 A1
(43) Pub. Date: May 11, 2006

(54) Remote controllable key, and a locking system including the key

(76) Inventor: Shuji Yoshizaki, Vienna, VA (US)

Correspondence Address: Shuji Yoshizaki, 2819 Shawn Leigh Dr., Vienna, VA, 22181, US

(21) Appl. No.: 10/983,675

(22) Filed: Nov. 9, 2004

(51) Int. Cl. H04Q 1/00; G05B 19/00

(52) U.S. Cl. 340/5.72; 340/825.69

(57) ABSTRACT

The present invention provides a key 1 for locking and unlocking a door 102 of an automobile. The key 1 has a key body 2 having a top 3 and a base 4, and a grip 7 provided on the base 4, having a first surface 8 and a second surface 9 opposed to the first surface. The first surface 8 meets with the second surface 9 at an edge 10. The key also has a first button 11 provided on the edge 10, and a second button 12 provided on the edge 10. The first button 11 is pushed to lock or unlock the door 102, and contrary, the second button 12 is pushed to unlock or lock the door 102.

### FIELD OF THE INVENTION

The present invention relates to an automobile, and specifically to a lock system thereof, and more specifically to a key thereof.

### RELATED ART

Conventionally, a remote controller for locking the doors of an automobile is there. It is provided separately from the key. The key and the remote controller generally lock and unlock the doors, so that two buttons are necessary for the remote control. However, it is inconvenient because the users have to carry both of the key and the remote controller.

One modification is to integrate the key with the remote controller. However, this modification forms only one button, which alternatively changes the function of the button to lock and unlock the doors every time when being pushed. Thus, the users feel uncertain whether the doors are locked. The users sometimes have to look into the doors to check that the doors are actually locked, before leaving the automobile. Further modification is to flash predetermined numbers of the light. For example, one flash is generated at the time of being locked, and two flashes are generated at the time of being unlocked. However, users confuse which is which. The present invention is provided in view of such inconvenience.

### SUMMARY OF THE INVENTION

There is provided a key for locking and unlocking a door of an automobile. The key has a key body having a top and a base. The key also has a grip provided on the base. The grip has a first surface and a second surface opposed to the first surface, the first surface meeting with the second surface at an edge. The key also has a first button and a second button provided on the edge. The first button is pushed to lock or unlock the door, and contrary, the second button is pushed to unlock or lock the door.

The first button is generally provided on the edge spaced from the base by a first interval, and the second button is generally provided on the edge spaced from the base by a second interval. In one embodiment of the present invention, the first interval is designed to be shorter than the second interval.

There is also provided a novel lock system of the present invention.

### BRIEF DESCRIPTION OF THE PRESENT INVENTION

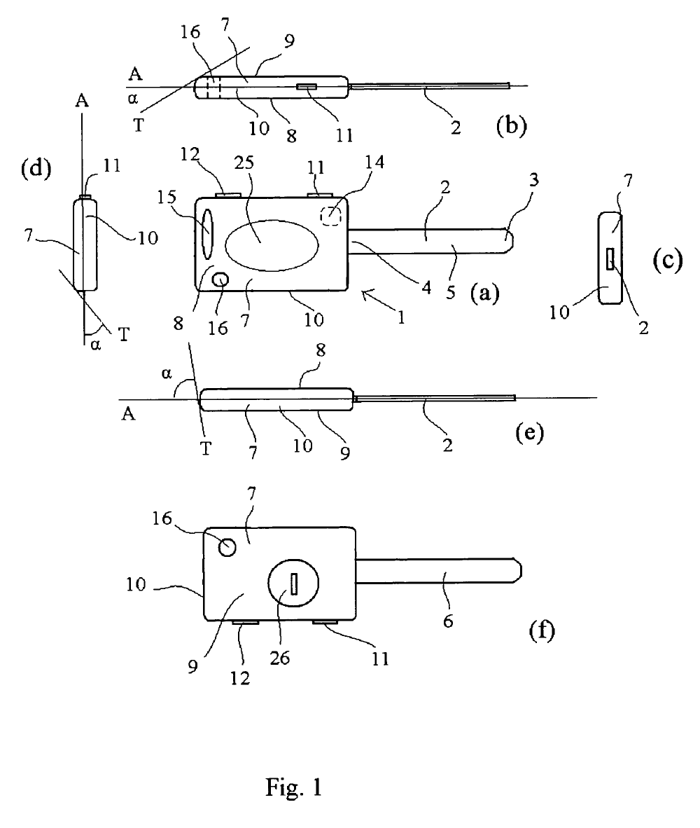

FIG. 1 illustrates six surfaces of a key of one embodiment of the present invention, FIG. 1(a) illustrating a plan view thereof, FIG. 1(b) illustrating a top view thereof, FIG. 1(c) illustrating a right side view thereof, FIG. 1(d) illustrating a left side view thereof, FIG. 1(e) illustrating a bottom view thereof, and FIG. 1(f) illustrating a back side view thereof.

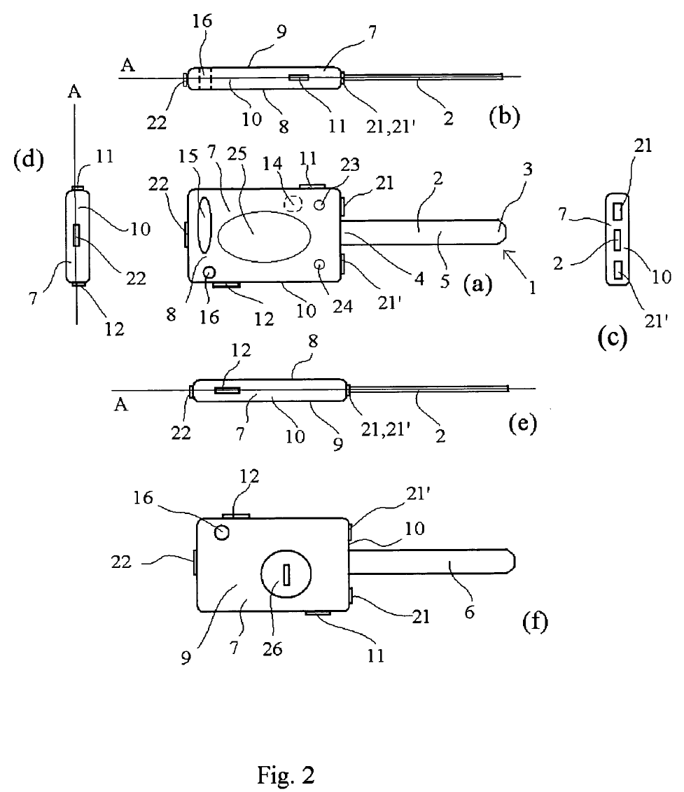

FIG. 2 illustrates a key of another embodiment of the present invention, FIG. 2(a) illustrating a plan view thereof, FIG. 2(b) illustrating a top view thereof, FIG. 2(c) illustrating a right side view thereof, FIG. 2(d) illustrating a left side view thereof, FIG. 2(e) illustrating a bottom view thereof, and FIG. 2(f) illustrating a back side view thereof.

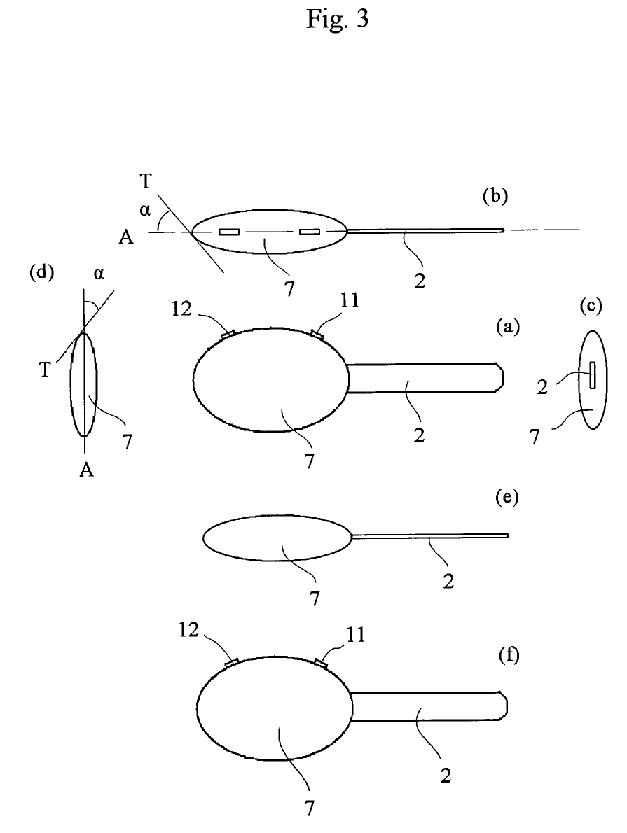

FIG. 3 illustrates a key of another embodiment of the present invention, FIG. 3(a) illustrating a plan view thereof, FIG. 3(b) illustrating a top view thereof, FIG. 3(c) illustrating a right side view thereof, FIG. 3(d) illustrating a left side view thereof, FIG. 3(e) illustrating a bottom view thereof, and FIG. 3(f) illustrating a back side view thereof.

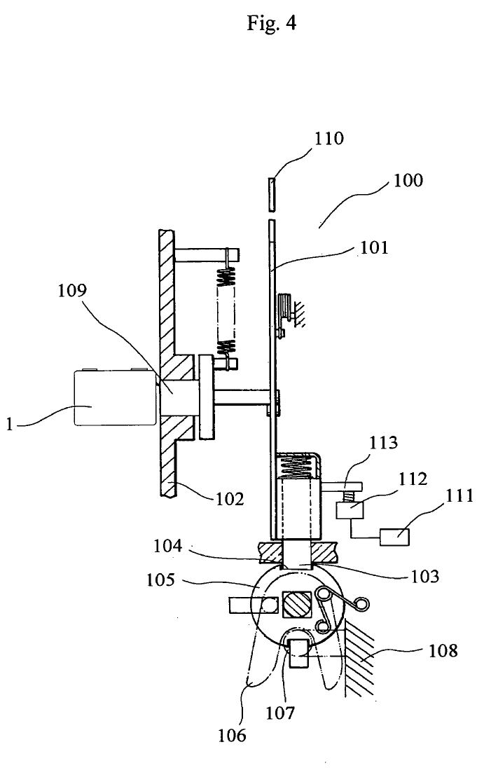

FIG. 4 illustrates a key mechanism incorporating the key of FIG. 2.

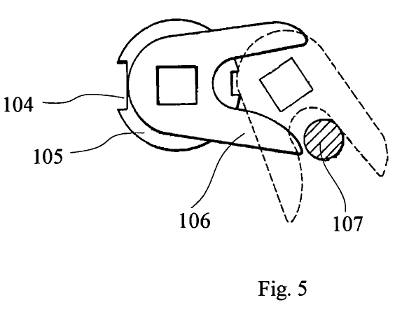

FIG. 5 illustrates a key mechanism incorporating the key of FIG. 2.

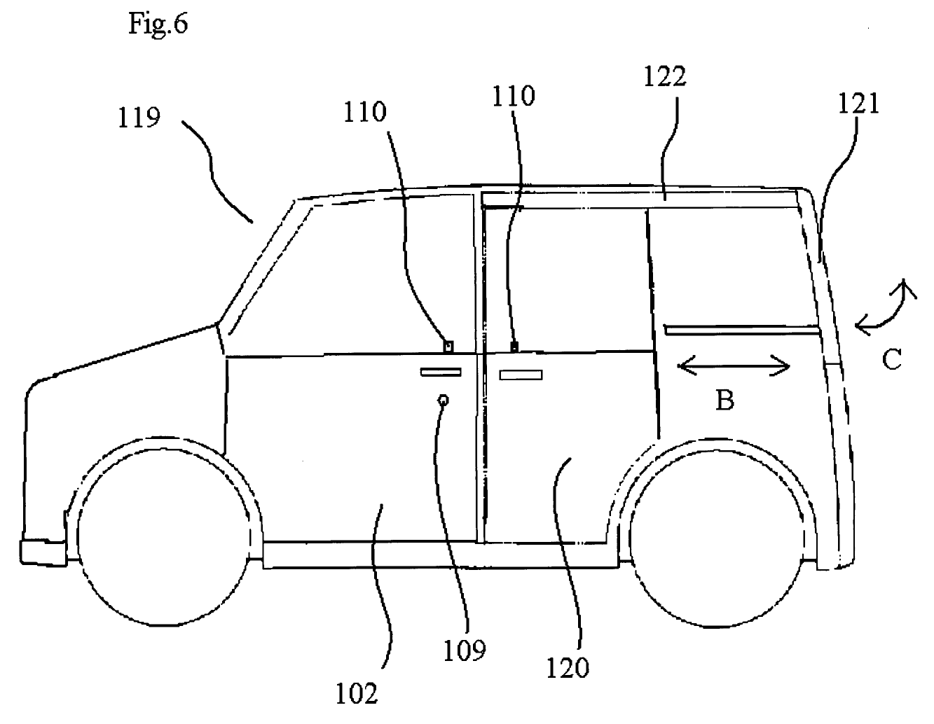

FIG. 6 illustrates an automobile incorporating the key mechanism of FIG. 4.

As shown in FIG. 1, the key 1 of the present invention has a key body 2 having a top 3 and a base 4. The key body 2 extends in a plane A. The plane A is a plane parallel to FIG. 1(a), or a plane including line A shown in FIGS. 1(b), (d) and (e) and perpendicular to the drawings. The key body 2 generally has a front surface 5 and a back surface 6, which are generally parallel to the plane A. The key 1 also has a grip 7 formed on the base 4. The grip 7 has a first surface 8 and a second surface 9 opposed to the first surface. The first surface 8 meets with the second surface 9 at an edge 10 of the grip 7. The edge 10 generally corresponds to a portion on the grip 7 where an angle α formed between a tangent line T and the plane A is 45° to 90°, as shown in Figs. (b), (d) and (e). On the other hand, a portion on the grip 7, where an angle α formed between a tangent line T and the plane A is 0° to less than 45°, generally corresponds to the first surface 8 or the second surface 9 of the grip 7. The first surface has a logo mark 25 and the second surface has a lid 26, which can be opened for replacing a battery.

The grip 7 of the present invention is provided with a first button 11 and a second button 12 on the edge 10. In the embodiment, by pushing the first button 11, a first signal is generated from the transmitter 14, provided inside the grip as shown in the dashed line, to lock the doors, and by pushing the second button 12, a second signal is generated from the transmitter 14 to unlock the doors. Provision of the buttons 11, 12 on the edge 10 can avoid unintentional contact to or operation of the buttons at the time of starting the engine. Prevention of the unintentional contact to the buttons at the time of starting the engine is also advantageous to improve the durability of the remote controller, because the key is gripped strongly when starting the engine. Thus, it is advantageous to provide the first and second buttons 11, 12 on the edge 10.

In particular, the first button 11 is provided more closely to the key body 2, especially to the base 4, than the second button 12. In other words, the interval between the key body 2 and the first button 11 is shorter than the interval between the key body 2 and the second button 12. Those intervals should be compared from the same point on the key body 2 or base 4. Also, the intervals are generally measured along the edge.

The configuration in the embodiment implies that the button 11 closer to the key body 2 locks the doors and the button 12 further to the key body 2 unlocks the doors. However, this configuration can be changed into the contrary. The difference between the first interval and the second interval is perceptible to the fingers holding the key 1. As the owner uses the key of the present invention for a while, the owner learns the functions allocated to the buttons, to recognize the configuration of the buttons automatically or subconsciously. Thus, the owner can push a necessary button without checking or seeing the remote controller. The key of the present invention can be thus used in the darkness or in a pocket.

The grip 7 is also provided with a panic button 15 on the first surface 8. The panic button 15 is formed not to be protruded from the first surface. Rather, the panic button 15 is formed to be slightly recessed from the first surface 8 in order to be unintentionally pushed. By pushing the panic button 15, the automobile continuously honks the horn. The panic button 15 may be formed on the edge 10. An opening 16 is provided on the grip 7 which can be used for attaching the key to a key holder.

FIG. 4 shows a locking mechanism 100 of the present invention. The locking mechanism has a plate bar 101, which can be moved up and down to unlock and lock the door 102. The top end 110 of the plate bar 101 is protruded from the door 102, as shown in FIG. 6. When the top end 110 is pushed down, the plate bar 101 is moved down as shown in FIG. 4. The lock bar 103 is engaged with a groove 104 on the rotating member 105, on which the engaging plate 106 is fixed. Thereby, the engaging plate 106 is locked with maintaining the engagement with the frame bar 107. Since the frame bar 107 is fixed on the body 108 of the automobile, the door 102 is locked.

On the other hand, when the top end 110 is pulled up, the plate bar 101 is moved up and the lock bar 103 is moved up from the groove 104. Thereby, the rotating member 105 together with the engaging plate 106 can be rotated, as shown in FIG. 5, to open the door 102. Also, the key body 2 of the key 1 can be inserted into a lock cylinder 109. When the key is appropriately rotated, the plate bar 101 is moved up or down to unlock or lock the door 102.

In the embodiment shown in FIG. 4, a receiver 111 is incorporated in the locking mechanism 100 of the present invention. The receiver 111 controls an actuator 112 provided on a side bar 113. The side bar 113 is fixed to the upper portion of the lock bar 103. When pushing the first button 11, a first signal is generated by the transmitter 14, which is received by a receiver 111 to operate the actuator 112 to move the lock bar 103 down. On the contrary, when pushing the second button 12, a second signal is generated by the transmitter 14, which is received by a receiver 111 to operate the actuator 112 to move the lock bar 103 up.

FIG. 2 is a second embodiment of the present invention. The same portions as the first embodiment are shown as the same symbols. The second embodiment is advantageous for application in an automobile having an automatic sliding doors and an automatic back door, as shown in FIG. 6. In addition to the first and the second buttons 11, 12, the key of the second embodiment has third buttons 21, 21′ on the edge 10 of the grip 7. Each of the third buttons 21, 21′ is spaced from the base by a third interval. The first, the second and the third intervals are different with one another, so that the owner of the automobile can recognize the configuration of the buttons subconsciously so as to push a necessary button without seeing the remote controller.

By pushing the third buttons 21, 21′, a third signal is generated to open and close the automatic sliding doors. The third button 21 controls the right side sliding door (not shown in FIG. 6), and the third button 21′ controls the left side sliding door 120. In FIG. 6, when the third button 21′ is pushed, the left side sliding door 120 is moved in the direction shown as arrow B.

The key of the second embodiment also has a fourth button 22 on the edge. The fourth button is spaced from the base by a fourth interval. By pushing the fourth button 22, the back door or trunk door 121 of the automobile 119 is automatically opened or closed in the direction as shown as arrow C. The opening and closing of the back door 119 are alternatively changed every time the fourth button 22 is pushed. The first, the second and the fourth intervals are different with one another, so that the owner of the automobile can recognize the configuration of the buttons subconsciously so as to push a necessary button without seeing the remote controller.

The key of the second embodiment is also provided with a first LED 23 (red LED) and a second LED 24 (blue or white LED). There is no limitation as to where they are installed. The first LED 23 and the second LED 24 are provided on the first surface in the second embodiment. The first LED 23 emits a red light when pushing the first button 11, and the second LED 24 emits a blue or white light when pushing the second button 12. The difference in color of the LEDs can help the user to recognize whether the door is locked or unlocked. The red light implies stopping or locking.

In the second embodiment, the first surface 8 and the second surface 9 of the grip 7 are made of a transparent material. Thus, when emitting the first and second LEDs 23, 24, the whole of the grip 7 is made luminous. Not limited to the whole of the surfaces 8, 9, at least a portion of the surfaces 8, 9 can be made of such a transparent material.

FIG. 3 is a third embodiment of the present invention. According to the present invention, the edge is defined by the angle α as explained before.

What is claimed is:

1: A key for locking and unlocking a door of an automobile, comprising:
a key body having a top and a base;
a grip provided on the base, having a first surface and a second surface opposed to the first surface, the first surface meeting with the second surface at an edge; and
a first button provided on the edge,
a second button provided on the edge; wherein the first button is pushed to lock or unlock the door, and contrary, the second button is pushed to unlock or lock the door.

2: A key according to claim 1, wherein the first button is provided on the edge spaced from the base by a first interval, wherein the second button is provided on the edge spaced from the base by a second interval, wherein the first interval is shorter than the second interval.

3: A key according to claim 1, further comprising a third button provided on the edge spaced from the base by a third interval, wherein the first, the second and the third intervals are different with one another, and wherein the third button is pushed to alternatively open and close a sliding door of the automobile.

4: A key according to claim 1, further comprising a fourth button provided on the edge spaced from the base by a fourth interval, wherein the first, the second, the fourth intervals are different with one another, and wherein the fourth button is pushed to alternatively open and close a back door of the automobile.

5: A key according to claim 1, further comprising a first LED provided on the grip and a second LED provided on the grip, wherein the first LED emits a first light when pushing the first button, and the second LED emits a second light when pushing the second button, wherein the first light is different in color from the second light.

6: A key according to claim 5, wherein at least a portion of the first and the second surfaces are made of a transparent material.

7: A lock system, comprising:
a locking mechanism provided on the door; and
a key, comprising:
a key body having a top and a base;
a grip provided on the base, having a first surface and a second surface opposed to the first surface, the first surface meeting with the second surface at an edge; and
a first button provided on the edge,
a second button provided on the edge; wherein the first button is pushed to lock or unlock the door, and contrary, the second button is pushed to unlock or lock the door.

8: A key according to claim 7, wherein the first button is provided on the edge spaced from the base by a first interval, wherein the second button is provided on the edge spaced from the base by a second interval, wherein the first interval is shorter than the second interval.

9: A key according to claim 7, further comprising a third button provided on the edge spaced from the base by a third interval, wherein the first, the second and the third intervals are different with one another, and wherein the third button is pushed to alternatively open and close a sliding door of the automobile.

10: A key according to claim 7, further comprising a fourth button provided on the edge spaced from the base by a fourth interval, wherein the first, the second, the fourth intervals are different with one another, and wherein the fourth button is pushed to alternatively open and close a back door of the automobile.

11: A key according to claim 7, further comprising a first LED provided on the grip and a second LED provided on the grip, wherein the first LED emits a first light when pushing the first button, and the second LED emits a second light when pushing the second button, wherein the first light is different in color from the second light.

12: A key according to claim 11, wherein at least a portion of the first and the second surfaces are made of a transparent material.

13: An automobile comprising the locking mechanism according to claim 7.
